(19) United States
(12) Patent Application Publication
(10) Pub. No.: US 2020/0226698 A1
(43) Pub. Date: Jul. 16, 2020

(54) SMART KITCHEN INFORMATION MANAGEMENT

(71) Applicant: TAYLOR COMMERCIAL FOODSERVICE INC., ROCKTON, IL (US)

(72) Inventors: Robert A. Chopko, Baldwinsville, NY (US); Thibaut Gavignet, Liverpool, NY (US); David C. Brondum, Cazenovia, NY (US); Jeremy Dobrowolski, Rockford, IL (US); Andreas Wallmeyer, Recke (DE); Lewis Gordon Curtis, Georgetown, NY (US)

(21) Appl. No.: 16/063,667

(22) PCT Filed: Dec. 13, 2016
(86) PCT No.: PCT/US2016/066288

§ 371 Date: Jun. 18, 2018

Related U.S. Application Data
(60) Provisional application No. 62/269,231, filed on Dec. 18, 2015.

(51) Int. Cl. G06Q 50/12; G06Q 10/08

(52) U.S. Cl. CPC G06Q 50/12; G06Q 10/087

(57) ABSTRACT

The present disclosure related to order fulfillment. Order fulfillment includes tracking products deposited into a storage module to produce delivery information and tracking the products withdrawn from the storage module to produce withdrawal information. Further, order fulfillment includes determining whether a delivery is required to replenish the products based on the delivery information and the withdrawal information and communicating a delivery notification to replenish the products in response to the determining that the delivery is required.

### BACKGROUND

In general, a delivery quantity and/or conditions of a delivery are not electronically linked to an inventory of a store. For example, a temperature of a product that enters a walk-in freezer-cooler of a commercial restaurant is not linked to the delivery itself. In addition, products entering the store take several redundant, circuitous paths to its final processing destination. The lack of an electronic link, in conjunction with redundant, circuitous paths, creates inefficiencies with respect to store management that cost time and money.

### BRIEF DESCRIPTION

According to an embodiment, a method for order fulfillment is provided. The method includes tracking, by a processor coupled to a memory, products deposited into a storage module to produce delivery information; tracking, by the processor, the products withdrawn from the storage module to produce withdrawal information; determining, by the processor, whether a delivery is required to replenish the products based on the delivery information and the withdrawal information; and communicating, by the processor, a delivery notification to replenish the products in response to the determining that the delivery is required.

According to another embodiment or the method embodiment above, the storage module can comprises a deposit end, a withdrawal end, a first tracking device that performs the tracking of the products deposited, and a second tracking device that performs the tracking of the products withdrawn.

According to another embodiment or any of the method embodiments above, the storage module can comprise a deposit end, a withdrawal end, and a conveyer, wherein the storage module can be pitched in a downward direction form the deposit end to the withdrawal end, and wherein the products can move along the conveyer in a direction of the pitch.

According to another embodiment or any of the method embodiments above, the storage module can be one of a plurality of storage modules, and wherein the delivery information can include an accumulation of tracked products across the plurality of storage modules.

According to another embodiment or any of the method embodiments above, the method can further comprise managing temperatures of the storage modules and monitoring a shelf life of the products to produce system information.

According to another embodiment or any of the method embodiments above, the determining of whether the delivery is required to replenish the products can be based on the delivery information, the withdrawal information, and system information.

According to another embodiment or any of the method embodiments above, the storage module can be one of a plurality of storage modules, and wherein the plurality of storage modules can include a reverse module configured to receive empty packages.

According to an embodiment, a system for order fulfillment is provided. The system includes tracking products deposited into a storage module to produce delivery information; tracking the products withdrawn from the storage module to produce withdrawal information; determining whether a delivery is required to replenish the products based on the delivery information and the withdrawal information; and communicating a delivery notification to replenish the products in response to the determining that the delivery is required.

According to another embodiment or the system embodiment above, the storage module can comprises a deposit end, a withdrawal end, a first tracking device that performs the tracking of the products deposited, and a second tracking device that performs the tracking of the products withdrawn.

According to another embodiment or any of the system embodiments above, the storage module can comprise a deposit end, a withdrawal end, and a conveyer, wherein the storage module can be pitched in a downward direction form the deposit end to the withdrawal end, and wherein the products can move along the conveyer in a direction of the pitch.

According to another embodiment or any of the system embodiments above, the storage module can be one of a plurality of storage modules, and wherein the delivery information can include an accumulation of tracked products across the plurality of storage modules.

According to another embodiment or any of the system embodiments above, the system can further perform managing temperatures of the storage modules and monitoring a shelf life of the products to produce system information.

According to another embodiment or any of the system embodiments above, the determining of whether the delivery is required to replenish the products can be based on the delivery information, the withdrawal information, and system information.

According to another embodiment or any of the system embodiments above, the storage module can be one of a plurality of storage modules, and wherein the plurality of storage modules can include a reverse module configured to receive empty packages.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 depicts a system for distributing product to a storage modules according to an embodiment;

FIG. 2 depicts an example of a storage module according to an embodiment;

FIG. 3 depicts an example operation of a plurality of storage modules according to an embodiment;

FIG. 4 depicts a process flow representing an example of an order fulfillment process according to an embodiment; and

FIG. 5 depicts a processing system according to an embodiment.

### DETAILED DESCRIPTION

Embodiments herein relate to a system of a store that utilizes at least one storage module configured to store a product. Each storage module of a plurality of storage modules can thus store a specific product, such that the plurality of storage modules can replace or mimic any inventory storage facility of a store, such as a contemporary walk-in freezer-cooler of a restaurant. In turn, the store can move away from long-term storage of products, and instead choose fresh and/or recently produce products stored in the plurality of storage modules.

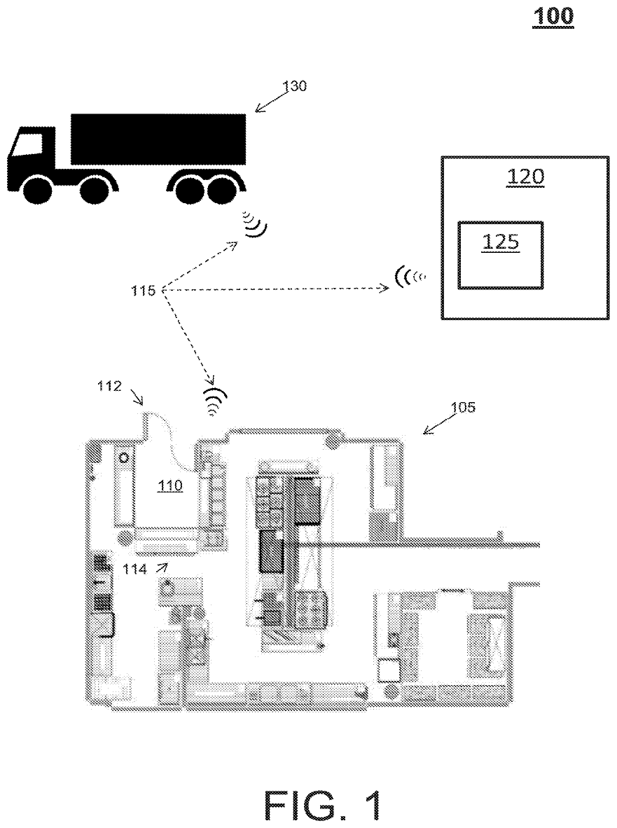

Turning now to FIG. 1, a system 100 for distributing product is generally shown in accordance with an embodiment. The system 100 includes a store 105 with a storage module 110, a deposit area 112, and a processing destination 114. Further depicted is communication 115 between the store 105, a distribution center 120 (e.g., the computer sub-system 125), and a delivery service 130.

The store 105 is representative of any quick-serve store, facility, or restaurant with a high volume turnover of products. For example, the store 105 can be a quick serve restaurant for serving fast, efficient, take-out-ready products, such as food products that experience a high-turn over time. While the term “quick-serve” can include and/or be synonymous with “fast food,” quick-serve is a broader term that extends beyond fast food to include kiosks, food stands, food trucks, drive-throughs, coffee shops, cafes, drive-ins, dinners, convenience stores, deli shops, and like. The deposit area 112 is an access via to the storage module 110 and is located with respect to an external wall of the store 105 to enable re-stocking deliveries from outside the store 105 without disturbing the employees inside the restaurant or creating delivery traffic around the processing destination 114.

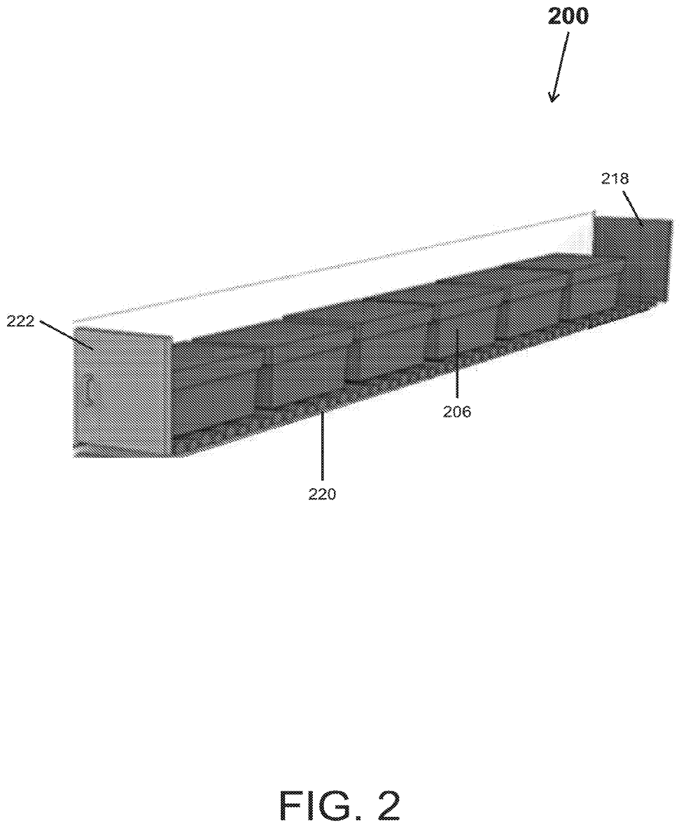

The storage module 110 of the system 100 facilitates storing products in a ready-to-use state for a short term. Turning now to FIG. 2, an example of the storage module 110 is depicted as a storage module 200 according to an embodiment. A storage module 200 can be an elongated container for storing products 206 including a deposit end 218, a set of rollers 220 (e.g., conveyers or the like), and a withdrawal end 222. The storage module 200 can be temperature controlled for a specific type of product. Note that the storage module 200 can be pitched or inclined in a downward direction from the deposit end 218 to the withdrawal end 222 so that the products 206 utilize gravity in conjunction with the set of rollers 220 to transition towards the withdrawal end 222.

Returning to FIG. 1, the storage module can be centrally located to enable employees of a store 105 to access a product from a single location while reducing a walking time and reducing product idle time between the storage module 110 and a stocking or processing area. The storage module can also be located with respect to an external wall of the store to enable re-stocking deliveries from outside the store 105 without disturbing the employees inside the store 105. The storage module, products, and system of the store can also utilize tracking technology to monitor the products entering and exiting into the storage module 110.

The storage module 110 includes electrical circuitry that provides the ability to track what products have been placed in the storage module 110, track changes to the products within the storage module 110, track what products have been removed in the storage module 110, and track inventory of the products with respect to inventory thresholds. The electrical circuitry of the storage module 110 can include any scanner, transceiver, optical detector capable of counting product inventory and broadcasting a notification to elements of the system 100.

Inventory thresholds are metrics designed to trigger notifications at a point when a particular amount of a product is sufficiently low that the product needs to be restocked. Without restocking, the product will be depleted, and the store 105 will not be able to serve that depleted product. Examples of Inventory thresholds include but are not limited to fixed values, fixed integers, ranges, and rate of change. Inventory thresholds can be associated and/or managed with respect to time metrics, such as a first inventory threshold can be a fixed integer during off-peak hours for the store 105 and change to a rate of depletion during peak-hours.

Notifications, in general, are identifying information (or non-existence of the information) targeted to systems or users responsible for the deliveries. Examples of notifications may include, but are not limited to, any combination of audio alerts (e.g., bu5ers, bells, tones, telephone calls, cellphone calls, VoIP calls, voicemails, loudspeaker announcements, etc.), visual displays (e.g., flashing lights, display pop-ups), pager (e.g., SNPP), electronic mail (e.g., POP, IMAP, SMTP), desktop alerts (e.g., dialog, balloon, modal window, toast, etc.), instant messaging (e.g., IRC, ICQ, AIM, Yahoo! Messenger, MSN, XMPP, iMessage), text messaging (e.g., SMS), and the like.

In an embodiment, the store 105 can include appliances and other devices that can work independent of or in conjunction with the storage module 110 to track products. For instance, an appliance, such as a fryer, can include electrical circuitry that provides the ability to track an amount of products cooked. The amount of products cooked can relate to cycles of operation over time, weight of food cooked, etc. In turn, this information can be utilized to verify a rate of change of product inventory to support anticipatory deliveries as described below.

The communication 115 between the elements of the system is representative of any communication scheme that facilities automatic and/or instant electronic interaction between the store 105, the storage module 110, the distribution center 120, the computer sub-system 125, and/or a delivery service 130. A communication scheme can be any network, as further described below, capable of supporting multiple wire and wireless technologies and protocols.

The distribution center 120 can be any facility or other specialized building (e.g., with refrigeration) that stocks products for distribution to the store 105. The distribution center 120 includes the computer sub-system 125 to perform an order fulfillment process, as further described below. Distribution centers are usually thought of as being demand driven. Examples of the distribution center 120 include but are not limited to a fulfillment center, warehouse, a cross-dock facility, a bulk break center, and a package handling center.

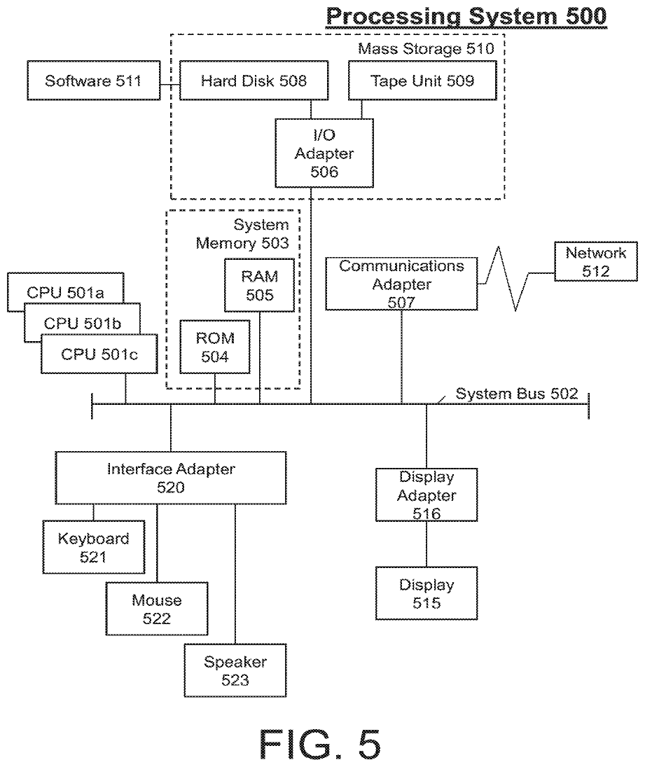

The computer sub-system 125 can be any computing device, such as the processing system 500 of FIG. 5 described below. Note that the computer sub-system 125 can include or receive a computer readable storage medium (or media) having computer readable program instructions thereon for causing a processor of the computer sub-system 124 to carry out aspects of the order fulfillment process.

The delivery service 125 can be any transportation mechanism for moving product from the distribution center 120 to the store 105. Examples of a delivery service include a delivery truck, a freezer truck, a train car service, a bicycle deliver service, and a driver-less vehicle service. In an embodiment, the delivery service 125 can include the computer sub-system 125 and the operations of the distribution center 120, such that the delivery service is a single mobile point for performing the order fulfillment process. Thus, the distribution center 120 and/or the delivery service 125 can be considered a distribution mechanism.

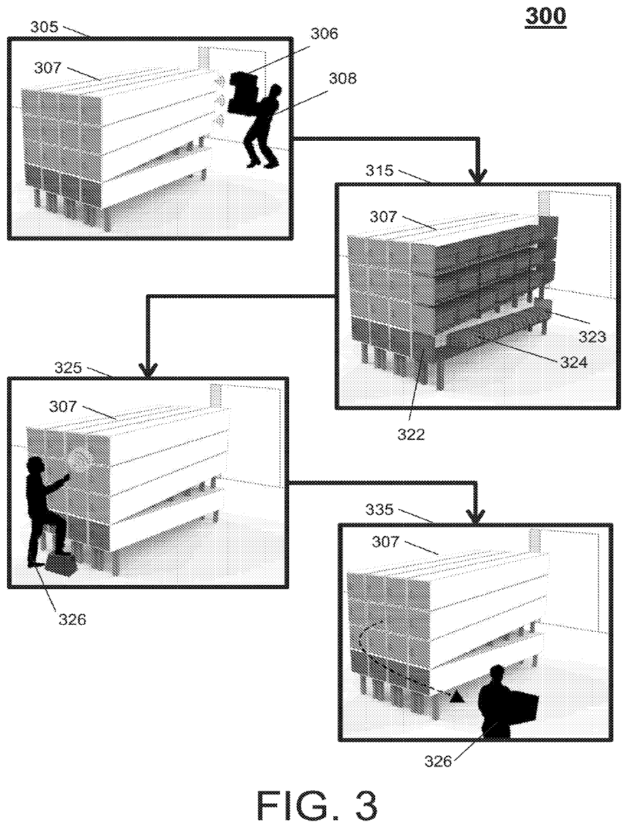

Turning now to FIG. 3, a process flow 300 depicting an example operation is generally shown in accordance with an embodiment. The process flow begins at block 305, where product packages 306 are inserted into the plurality of storage modules 307 by a delivery man 308. As each product package is inserted into a corresponding storage module of the plurality of storage modules 307, that product package is tracked by the corresponding storage module.

In an embodiment, each product package includes a radio frequency identification (RFID) chip. For example, RFID chips can be implanted on product packaging such that a product included in the product packaging can be tracked. Product packaging can include but is not limited to freezer boxes, freezer bags, shrink wrap, cardboard crates, and Styrofoam crates. An RFID scanner can then be utilized by the storage module 110 at a deposit end of each storage module 307 to track the deposit of each box. The RFID scanners, in turn, automatically update the store's inventory. The chips further allow each storage module 307 to track a box as in transit (e.g., from the delivery service 120 to the storage module 110 of the store 105, within portions of the storage module 110, and from the storage module 110 to a processing destination 114).

In another embodiment, code scanners can be utilized to track products. For example, barcodes or the like can be placed on an exterior of the product packaging 306 such that a product can be tracked as it transitions.

At block 315, the plurality of storage modules 307 creates a lean product supply that is flexible to fit a store's unique needs. In the example of block 315, the plurality of storage modules 307 is a 4 by 4 arrangement; however, any combination of rows and columns can be employed in a particular arrangement. The top three rows include storage modules for containing products to be used at the store. The modules in the bottom row are reverse modules. Reverse modules can be pitched or inclined in a downward direction from the deposit end 322 to the withdrawal end 323 so that the empty product packages 324 utilize gravity in conjunction with the set of rollers to transition towards the withdrawal end 323. The empty product packages 324 can be collapsible boxes to be picked up by the delivery man 308 at the next time of delivery.

At block 325, an employee 326 can chose product from the plurality of storage modules 307 on store demand and inventory status. Again, RFID scanners update the inventory as the product packages 306 are withdrawn from the plurality of storage modules 307 by the employee 326.

At block 335, the employee 326 returns to a processing destination with the withdrawn product package 306. Note that a shorter path to the processing destination is now possible with the central location of the modules.

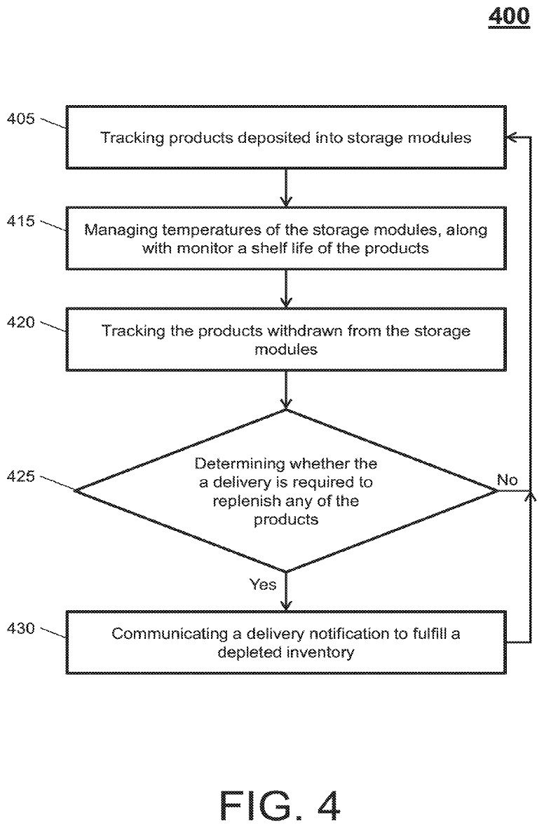

FIG. 4 depicts a process flow 400 representing an example of an order fulfillment process according to an embodiment. At block 405, tracking of products deposited into storage modules is performed. Delivery information can be accumulated across the storage modules. In this regard, electrical circuitry of the storage modules (or the computer sub-system 125 based on receiving the delivery information) can be configured to monitor the delivery information.

At block 415, managing temperatures of the storage modules, along with monitoring a shelf life of the products, is performed. For example, the electrical circuitry of the storage modules (or the computer sub-system 125 based on receiving the delivery information) can be configured to track and manage the temperatures of each storage module to keep product at a specific temperature. Further, the electrical circuitry of the storage modules can track system information, such as time of day, a time to delivery, inventory need, product priority, product type, etc. This system information can also include product movement and/or weight of packages within the storage modules.

At block 425, tracking of products withdrawn from the storage modules is performed. Withdrawal information can be accumulated across the storage modules. In this regard, the electrical circuitry of the storage modules (or the computer sub-system 125 based on receiving the delivery information) can be configured to monitor the withdrawal information.

In turn, at block 420, a determination is made as to whether a delivery is required to replenish any of the products. The electrical circuitry of the storage modules or the computer sub-system 125 can perform this determination. In an embodiment, the determination includes making a comparison between delivery information, system information, and withdrawal information.

If the computer sub-system 125 determines that a delivery is not required based on the tracked delivery information, then the process flow 400 can loop back to tracking at block 405 (as indicated by the No arrow). If the computer sub-system 125 determines that a delivery is required, then the process flow 400 proceeds to block 430 (as indicated by the Yes arrow).

At block 430, communicating of a delivery notification to fulfill a depleted inventory is performed. The electrical circuitry of the storage modules or the computer sub-system 125 can perform this communication. The delivery notification (e.g., a notification as described above) is communicated to the delivery service 125 to fulfill a depleted inventory. After the delivery notification is communicated, the process flow 400 can loop back to tracking at block 405.

Referring now to FIG. 5, there is shown an embodiment of a processing system 500 for implementing the teachings herein. In this embodiment, the processing system 500 has one or more central processing units (processors) 501a, 501b, 501c, etc. (collectively or generically referred to as processor(s) 501). The processors 501, also referred to as processing circuits, are coupled via a system bus 502 to system memory 503 and various other components. The system memory 503 can include read only memory (ROM) 504 and random access memory (RAM) 505. The ROM 504 is coupled to system bus 502 and may include a basic input/output system (BIOS), which controls certain basic functions of the processing system 500. RAM is read-write memory coupled to system bus 502 for use by processors 501.

FIG. 5 further depicts an input/output (I/O) adapter 506 and a network adapter 507 coupled to the system bus 502. I/O adapter 506 may be a small computer system interface (SCSI) adapter that communicates with a hard disk 508 and/or tape storage drive 509 or any other similar component. I/O adapter 506, hard disk 508, and tape storage drive 509 are collectively referred to herein as mass storage 510. Software 511 for execution on processing system 500 may be stored in mass storage 510. The mass storage 510 is an example of a tangible storage medium readable by the processors 501, where the software 511 is stored as instructions for execution by the processors 501 to perform a method, such as the process flows of FIG. 4. Network adapter 507 interconnects system bus 502 with an outside network 512 enabling processing system 500 to communicate with other such systems. A screen (e.g., a display monitor) 515 is connected to system bus 502 by display adapter 516, which may include a graphics controller to improve the performance of graphics intensive applications and a video controller. In one embodiment, adapters 506, 507, and 516 may be connected to one or more I/O buses that are connected to system bus 502 via an intermediate bus bridge (not shown). Suitable 1/O buses for connecting peripheral devices such as hard disk controllers, network adapters, and graphics adapters typically include common protocols, such as the Peripheral Component Interconnect (PCI). Additional input/output devices are shown as connected to system bus 502 via an interface adapter 520 and the display adapter 516. A keyboard 521, mouse 522, and speaker 523 can be interconnected to system bus 502 via interface adapter 520, which may include, for example, a Super I/O chip integrating multiple device adapters into a single integrated circuit.

Thus, as configured in FIG. 5, processing system 505 includes processing capability in the form of processors 501, and, storage capability including system memory 503 and mass storage 510, input means such as keyboard 521 and mouse 522, and output capability including speaker 523 and display 515. In one embodiment, a portion of system memory 503 and mass storage 510 collectively store an operating system to coordinate the functions of the various components shown in FIG. 5.

Technical effects and benefits of embodiments herein include improving the temperature control of the food, improving the safety compliance of food handling in the restaurant, reducing the footprint of the restaurant kitchen area, improving the operation efficiency and inventory management. Technical effects and benefits of embodiments herein also include improving inventory management through tracking of the products (e.g., tracking threshold levels of the products, automatic signals to local distribution warehouse, and anticipatory deliveries), providing directed temperature control of the products, and managing energy consumption within the restaurant.

Embodiments herein may be a system, a method, and/or a computer program product. The computer program product may include a computer readable storage medium (or media) having computer readable program instructions thereon for causing a processor to carry out aspects of the embodiments herein. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the embodiments herein.

Aspects of the embodiments herein are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions. In this way, the flowchart and block diagrams in the FIGS. illustrate the architecture, operability, and operation of possible implementations of systems, methods, and computer program products according to various embodiments. Further, each block in the flowchart or block diagrams may represent a module, segment, or portion of instructions, which comprises one or more executable instructions for implementing the specified logical operation(s). In some alternative implementations, the operations noted in the block may occur out of the order noted in the FIGS. For example, two blocks shown in succession may, in fact, be executed substantially concurrently, or the blocks may sometimes be executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A method for order fulfillment, comprising:
tracking, by a processor coupled to a memory, products deposited into a storage module to produce delivery information;
tracking, by the processor, the products withdrawn from the storage module to produce withdrawal information;
determining, by the processor, whether a delivery is required to replenish the products based on the delivery information and the withdrawal information; and
communicating, by the processor, a delivery notification to replenish the products in response to the determining that the delivery is required.

2. The method of claim 1, wherein the storage module comprises a deposit end, a withdrawal end, a first tracking device that performs the tracking of the products deposited, and a second tracking device that performs the tracking of the products withdrawn.

3. The method of claim 1, wherein the storage module comprises a deposit end, a withdrawal end, and a conveyer, wherein the storage module is pitched in a downward direction form the deposit end to the withdrawal end, and wherein the products move along the conveyer in a direction of the pitch.

4. The method of claim 1, wherein the storage module is one of a plurality of storage modules, and wherein the delivery information includes an accumulation of tracked products across the plurality of storage modules.

5. The method of claim 1, further comprising managing temperatures of the storage modules and monitoring a shelf life of the products to produce system information.

6. The method of claim 1, wherein the determining of whether the delivery is required to replenish the products is based on the delivery information, the withdrawal information, and system information.

7. The method of claim 1, wherein the storage module is one of a plurality of storage modules, and wherein the plurality of storage modules includes a reverse module configured to receive empty packages.

8. A system, comprising a processor and a memory storing program instructions for order fulfillment thereon, the program instructions executable by the processor to cause the system to perform:
tracking products deposited into a storage module to produce delivery information;
tracking the products withdrawn from the storage module to produce withdrawal information;
determining whether a delivery is required to replenish the products based on the delivery information and the withdrawal information; and
communicating a delivery notification to replenish the products in response to the determining that the delivery is required.

9. The system of claim 8, wherein the storage module comprises a deposit end, a withdrawal end, a first tracking device that performs the tracking of the products deposited, and a second tracking device that performs the tracking of the products withdrawn.

10. The system of claim 8, wherein the storage module comprises a deposit end, a withdrawal end, and a conveyer, wherein the storage module is pitched in a downward direction form the deposit end to the withdrawal end, and wherein the products move along the conveyer in a direction of the pitch.

11. The system of claim 8, wherein the storage module is one of a plurality of storage modules, and wherein the delivery information includes an accumulation of tracked products across the plurality of storage modules.

12. The system of claim 8, the program instructions further executable by the processor to cause the system to perform managing temperatures of the storage modules and monitoring a shelf life of the products to produce system information.

13. The system of claim 8, wherein the determining of whether the delivery is required to replenish the products is based on the delivery information, the withdrawal information, and system information.

14. The system of claim 8, wherein the storage module is one of a plurality of storage modules, and wherein the plurality of storage modules includes a reverse module configured to receive empty packages.
